(19) United States
(12) Patent Application Publication
(10) Pub. No.: US 2011/0246301 A1
(43) Pub. Date: Oct. 6, 2011

(54) METHODS TO ACCESS PRODUCT PLACEMENT DATA

(76) Inventors: Ji Bae, Duluth, GA (US); Thomas V. Edwards, Suwanee, GA (US)

(21) Appl. No.: 12/751,313

(22) Filed: Mar. 31, 2010

(51) Int. Cl. G06Q 30/00

(52) U.S. Cl. 705/14.54; 705/346

(57) ABSTRACT

A method is provided to that allows product placement data of specific items to be conveniently accessed. A user may submit a request for a specific item or items via a client device (e.g., a mobile device, laptop, desktop, etc.) to a server. The server responds with product placement data for providers (e.g., retailers, stores, service providers, libraries, etc.) of the item or items that are close geographically to the user's location. Other data may be included with the response including pricing information of the item, distance or directions to the provider, and promotions.

### FIELD OF THE INVENTION

The present invention relates generally to product placement data.

### BACKGROUND

Customers may have difficulty when attempting to locate specific items in retail stores. Store formats and product placement of items may differ from retailer to retailer. Even with the same retailer, product placement may differ at two different locations within the same geographic area. To help the consumer locate specific items, retailers may install signage. For example, in a large warehouse hardware store, large signs might be placed at the end of aisles to indicate which items are located within that particular aisle. “Tools” might be placed in Aisle 7 and hence, a sign located at the end of Aisle 7 will state that “Tools” may be found within that particular aisle. However, signs have many limitations. Signs may be obscured by other objects, stock may be rotated within the store causing signs to be inaccurate, or signs may simply not be visible unless the user is located a short distance from the sign causing him to miss reading many of the signs.

In another example, an item might not fit into any particular category listed on a sign very distinctly. An apple might clearly fall within the category of fresh fruit and produce in a grocery store, but the location of trash bags might appear to fall into multiple categories causing confusion. Trash bags might be located in any of: cleaning products, household items, or picnic/party items. If items in these categories are located in different aisles within a store, then a consumer would have difficulty correctly guessing which aisle trash bags are located. Therefore, more direct and efficient techniques in which to locate a particular item within a store are important.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

Techniques are provided for receiving requests for product placement data for specific items and displaying product placement data to a consumer.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block illustration of a system for accessing product placement data, according to an embodiment of the invention;

FIG. 2 is an illustration of a workflow for accessing product placement data, according to an embodiment of the invention; and

FIG. 3 is a block diagram of a system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Methods and techniques are described that allow product placement data of specific items to be conveniently accessed. In an embodiment, a user may submit a request for a specific item or items via a client device (e.g., a mobile device, laptop, desktop, etc.) to a server. The server responds with product placement data for providers (e.g., retailers, stores, service providers, libraries, etc.) of the item or items that are close geographically to the user's location. Other data may be included with the response such as, but not limited to, pricing information of the item. In addition, incentives and promotions may be included by providers to encourage potential customers to visit.

### Sending the Request

A user may wish to quickly locate a specific item at a specific provider. For example, a spouse or teenage child might be sent out to pick up a few specific items needed for dinner. If the spouse or teenager were unfamiliar with the layout of a particular provider, then he would need additional time to locate and purchase the items. By providing the user with the specific location within a provider of where the item is located, time is saved and the user would be more likely to shop at the store in the future. As used herein, a “provider” may be any entity which provides goods or services. Examples include, but are not limited to, retailers (e.g. mom-and-pop stores, big box retailers, bookstores, grocery stores, etc.), libraries (to provide locations of specific books or services), government (city, county, or federal) services (to provide locations within public buildings that provide services such as obtaining permits or licenses, paying taxes or fees, auto registration, or public meetings), fairgrounds or amusement parks (to provide locations of specific attractions), or any other entity where providing specific locations of products or services at a provider would be helpful to a user.

In an embodiment, a request is submitted by the user via a client device (e.g., a mobile device, laptop, desktop, etc.) to a server that specifies a particular item. As used herein, an item may refer to one or more goods or services. The request may be sent in a variety of ways. For example, the request may be sent as a short message service (SMS) text message or as an email from a smartphone or other mobile device. The request may also be sent as part of an application that has previously been downloaded to the mobile device. For example, an application for any smartphone may be available for download whose purpose is for users to send requests for product placement data within providers. Requests may also be sent via a web page request on a computer, through an interactive voice recognition (IVR) system via phone call, or any other method that transmits data from one source to another.

In an embodiment, the request comprises a keyword to indicate that a search for product placement data is to occur and the specific item that is to be searched. As an example, a request in the form of a SMS text might appear “FIND canned tomato”. In the example, the keyword “FIND” indicates that a product placement search is to occur by a server. Other keywords may indicate performance of other functions or methods.

The next part of the request, “canned tomato” states the specific item that is sought by the user. The specific item may be in any form that may be used to specify an item. Examples include, but are not limited to, generic name of the product, a brand name of the product, SKU number, UPC number, nickname, or acronym. “Mayo” may indicate a search to find the location of mayonnaise, “tp” may indicate a search for tissue paper, or “PB&J” may indicate a request for the two items peanut butter and jelly. As indicated with “PB&J”, searches may also be made for more than one item with a single search.

In an embodiment, a request may also be submitted that states a general category of item. For example, this might be a particular category (organic, natural, etc.), a particular diet (diabetic, low-sugar, religious restrictions, etc.), or place of origin (only items sourced within 200 miles, French wine, etc.). These requests are also for more than one item within the search.

In an embodiment, location data that indicates providers in a particular area should be returned is included with the search request. Location data may be from the client device itself. In an embodiment, the location data are included based upon cellular location data extracted from a mobile device or cellular network. In another embodiment, location data might be indicated via the IP address of the mobile device. Though not as exact as using cellular locations, IP addresses might be identified to certain areas based upon geo-location tables that include IP blocks and general geographic locations where those IP blocks occur. This might occur when a request is sent over a Wi-Fi connection where the location of the mobile device might not be so apparent.

In an embodiment, location data may be overridden in the request by a user. Under this circumstance, the user might indicate (via address, zip code, geographic coordinates, store numbers, etc.) the area using the client device for which providers should be returned for his request. This might occur when a user is at his workplace beginning his journey home and would like to know product placement data for retailers near his home and not in the area of his workplace. In an embodiment, the specific provider is indicated by the user within the request on the client device. For example, a user might wish to know product placement data of an item within a specific grocery store near his home. A normal request might list other stores prior to the specific grocery store or the user might wish for product placement data for only the one specific grocery store. Under this circumstance, the request would return only product placement data for the store indicated within the request.

In an embodiment, other identification data is included in the request transmitted from the client device to help tailor a response to a particular user. For example, a user name or other identifying data might be included in the request from the client device so that the user submitting the request may be identified. Identification data may also be extracted based on the phone number of the mobile device that is used to send the request. Including identification data in a request from a client device allows responses to include personalized incentives or other promotions that may be of interest to the user of the client device. As the user makes more and more requests, these incentives may be improved and usage of the search system would increase. A tailored response from the server also allows the user to indicate how the response should be formatted.

In an embodiment, a user may include flags in a request to indicate how results are sorted in a response. For example, a list of providers sorted via distance away might be indicated by a “-d” at the end of the request or listings sorted by price might be indicated by “-p” in the request. These flags and types of sorts may vary from implementation to implementation and include far more variations than the examples described herein.

### Providing a Response

In an embodiment, a server would receive the request from the client device and provide a response to the client device making the request. As an example, the server might receive the request of the SMS text message “FIND canned tomato”. The server would first extract the first keyword “FIND” to determine that a product placement search is to occur. The server then parses the rest of the request “canned tomato” to determine what particular product should be searched. In another embodiment, no keyword may be included in the request as all requests received may be a request for product placement data. For example, the request might originate from a smartphone application that is dedicated to only making requests for product placement data. In another example, the server might exclusively perform product placement searches and all requests received will result in a product placement search.

In an embodiment, location data is parsed from the request to determine which providers are in proximity to the area desired by the user. This may be location data from the cellular location of the mobile device, or user provided location data. When the providers in proximity to the location are determined, then provider specific product placement data is searched to determine the actual product placement of the item within the particular provider. In an embodiment, a listing of each of the providers and product placement data for each of the providers is determined by the server. The entire listing, or a subset thereof, is transmitted as a response to the request. The proximity data of providers is integrated with product placement data of each of the providers. Integration of the data may occur at the server or at the client device depending upon the implementation. The integrated data is displayed to the user at the client device.

In an embodiment, additional information may be included in the response beyond the location of the item within the provider and the distance away of the provider. For example, hours of operations for each of the providers might be included. Under this circumstance, providers that are open for at least the next 20 minutes may be the only providers that are included in the response. In an embodiment, additional information that is included is specific based upon the type of item searched. For example, for food items, nutritional information might be included and for books, the author, page count, cover art, and a book jacket summary might be included. In another example, for items that may be rented vs. purchased (movies, party tents, helium tanks, etc.), options might be included of whether the item is available for rent or for purchase. In yet another example, whether the item is available and in inventory might be included. Additional information such as styles, colors, different models, etc. available for item might also be included with inventory information. Product information or features (for items such as electronics, etc.) may also be included. For additional information that may have a large amount of data (e.g. product specification, features, data beyond SMS text message maximum size, etc.), a link to that information may be included in the response.

In an embodiment, suggestions may also be offered with the response. For example, if a user searches for certain general types of items (e.g. organic foods), then other organic foods might also be returned in the response or as a link to an additional search that may be submitted by the user.

In an embodiment, incentive or promotion data is also sent with the response. For example, a specific provider in the list of providers might wish to encourage the consumer making the request to visit their store to make the purchase. The provider may insert a coupon at each instance where the provider's specific store is included in a response to a product placement data request. Promotions may also be targeted where coupons are included that specifically include the specific item that is requested by the user, or a coupon may be included that is related to the specific item that is requested. In another embodiment, event-driven promotional items that are not related to the item may also be included. For example, holiday related merchandise may be promoted depending upon the time of year. In yet another embodiment, the promotion may be for items that are based upon preferences expressed by the provider. For example, a store special might be offered where a time expiring product (fruit, vegetables, dairy, etc.) may be in excess supply and a special is offered to lower the existing stock.

In an embodiment, the coupon may be a digital code that is entered by the user at time of purchase, or may be an image of a UPC code that can be scanned in at time of purchase. In an embodiment, the digital code or UPC code may be unique to each response made to a request. By having each digital code or UPC code be unique, responses to requests with promotions may be tracked by the retailer to determine metrics for the promotion. These promotional metrics may include, but are not limited to, success rate for direct promotions and success rate for promotions of items related to the specific item requested. The promotional transaction data is correlated with search data to better target promotions in the future and determine whether the promotions are productive for the provider or to find which particular searches are best to advertise.

In an embodiment, the list of providers and product placement data may be sorted based upon various factors. For example, the list of providers might be displayed based upon the price of the specific item. In another example, the list of providers might be displayed based upon the geographic distance to the user. As another example, the list of providers might be sorted based upon flags submitted by the user making the request. In yet another example, providers might be listed based upon a relevance order based on the search. In a relevance based ordering, providers may be returned based upon the type of provider and products stocked. For example, a search of “yogurt” might return grocery stores at the top of the list even though a gas station with a convenience store carrying yogurt is closer to the user in distance. This listing result occurs because the grocery store has many more varieties of yogurt and is known for selling dairy items more readily than a gas station convenience store.

In another embodiment, retailers may provide compensation in order to be listed higher in the list of retailers returned. Placement based on compensation may be performed in a variety of ways. For example, all retailers who provide a particular amount of compensation might be placed ahead of all other retailers who did not provide any compensation. In another example, compensation might used as one factor of a plurality of factors to determine relevance for the order of providers in a list of providers.

In an embodiment, requests received from users are stored within a database and aggregated with other requests. The stored requests may be used to determine buying patterns of users or to determine the effectiveness of promotional incentives. For example, a user might submit a request for “cereal.” The response provided to the user included a discount coupon with a unique identifier that the user enters when making a purchase. The provider that makes the sale associates the unique identifier entered with the transaction and transmits transaction data to the search response provider. The transaction data may be used to generate sales metrics such as the success rate of a particular promotion of a provider. Product pairings or suggestions may also be included in the response should another specific product be frequently purchased when a search for a particular item is performed. For example, data might indicate that users who enter a search for “diapers” also frequently purchase milk on the same sales trip. Thus, providers may offer a promotion for the purchase of both milk and diapers when a search for “diapers” is received.

### Displaying the Response

In an embodiment, the client device receives the response for display on the client device. The response may be in a variety of forms. In an embodiment, the response is in the same form as the request. For example, if the request was made as a SMS text message, then the response might be in the form of a SMS text message. If the request was made as an email, then the response might be in the form of an email, etc. In another embodiment, the response is always in the form of an email or some other form of communication. In yet another embodiment, the response is in the form of a hyperlink where the user is taken to a webpage or location with the listings of providers and product placement data.

In an embodiment, each of the providers may be listed with their address, distance away from the location specified, and the associated product placement data for the specified item. The listing may be in the format of columns and rows, a numerical list, or any other format where the information is viewable for the user. Included with the listing may be additional information such as the price of the specified item, brands and prices of a specified item (e.g. different brands of yogurt, flavors, prices, etc.), a hyperlink to a map of the store that the user may follow, a hyperlink for directions to each specific provider, etc. The amount of information provided, how the information is sorted, and what information that is provided may be customizable by the user.

In an embodiment, the server performs the formatting and integrating of provider data with product placement data for each response. In another embodiment, the server only transmits provider information and product placement data and leaves how the information should be formatted for the user to the client device or application on the client device.

In an embodiment, the display may be used to overcome cultural or language barriers. For example, the search might help a traveler who does not understand a foreign language to locate an item in a foreign country (e.g. an American in Japan with no familiarity with Japanese). The results might be displayed in the preferred language (e.g. English) along with the store's literal signage (in Japanese) so that the user may navigate the Japanese store with greater ease. In an embodiment, the translations are performed by the client device. In another embodiment, the translations are performed by the server within the response.

In an embodiment, after the response is displayed, the user may provide feedback and review information about the search. For example, the user might be able to update information that is incorrect (wrong aisle, wrong signage to aisle, etc.) or out-of-date (item no longer carried, item out of stock, etc.). As another example, the user might be asked if the item is misplaced, or if the search information provided was helpful in the purchase. Additional information such as rating the shopping experience may also be provided by the user.

### Illustrated Example

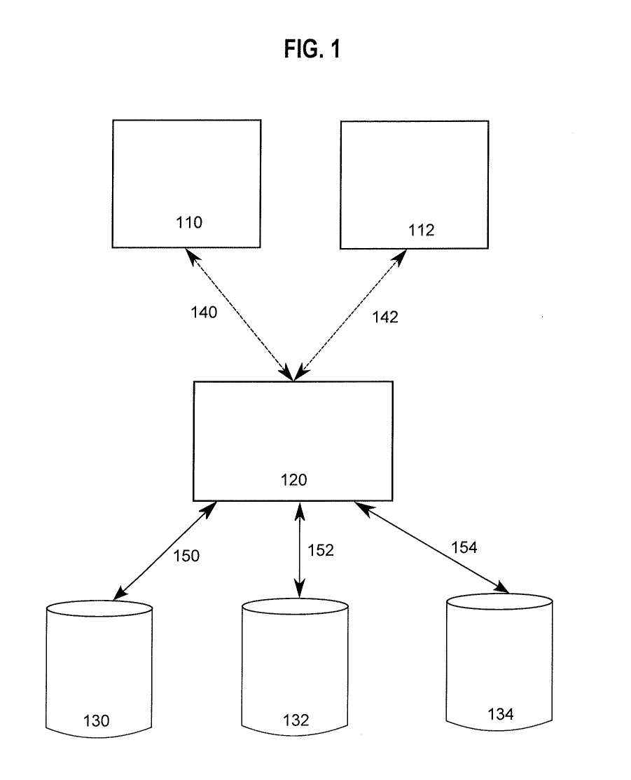

An example of an embodiment of the system is illustrated in FIG. 1. In FIG. 1, client 110 and client 112 may submit requests to server 120. The request from client 110 is submitted via network link 140 and the request from client 112 is submitted via network link 142. Network link 140 and 142 may comprise a cellular phone network link, a network link through the Internet, or any other type of network link upon which network communications may be sent. Once the server receives the request, the server accesses database 130, database 132, and database 134. Database 130 is the provider database that contains addresses of various providers for the good or service requested. Database 130 is connected to server 120 via network link 150. Database 132 is the product placement data database and contains information about the product placement for specific providers. Database 132 is connected to server 120 via network link 152. Database 134 is the promotions database and contains information about promotions to be included in search responses for specific providers. Database 134 is connected to server 120 via network link 154. Though the databases are shown separated in FIG. 1, databases 130, 132, and 134 may be combined to be within a single database or may also be further broken up into more databases. Furthermore, databases 130, 132, and 134 may be combined with server 120 and be in a single location rather than the distributed architecture as shown in FIG. 1. The actual architecture may vary from implementation to implementation and is not limited to those shown or described herein.

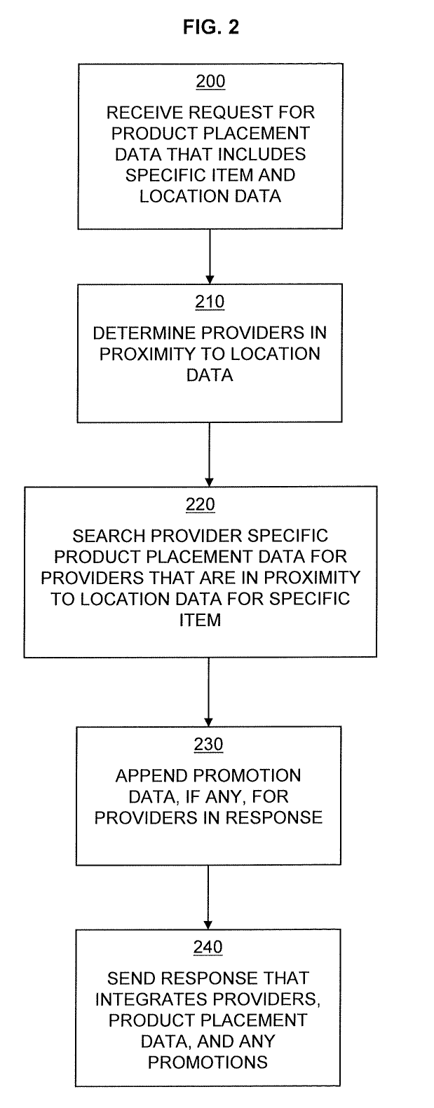

FIG. 2 illustrates steps performed in order to access product placement data. In step 200, a server (120) receives the request from a client (110 or 112) for product placement data. The request includes the specific item sought and the location data for which the user wants results returned. Next, the server (120) determines providers in proximity to the location specified in the location data (e.g. accessing provider database 130) as shown in step 210. In step 220, with the providers determined, the server (120) searches product placement data for the item specified for those providers (e.g. accessing product placement database 132). The server (120) then finds any promotional data that should be included with the listings and appends them in step 230 (e.g. accessing provider database 134). Finally, the server (120) sends the response back to the client (110 or 112) from which the request was sent for display to the user.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

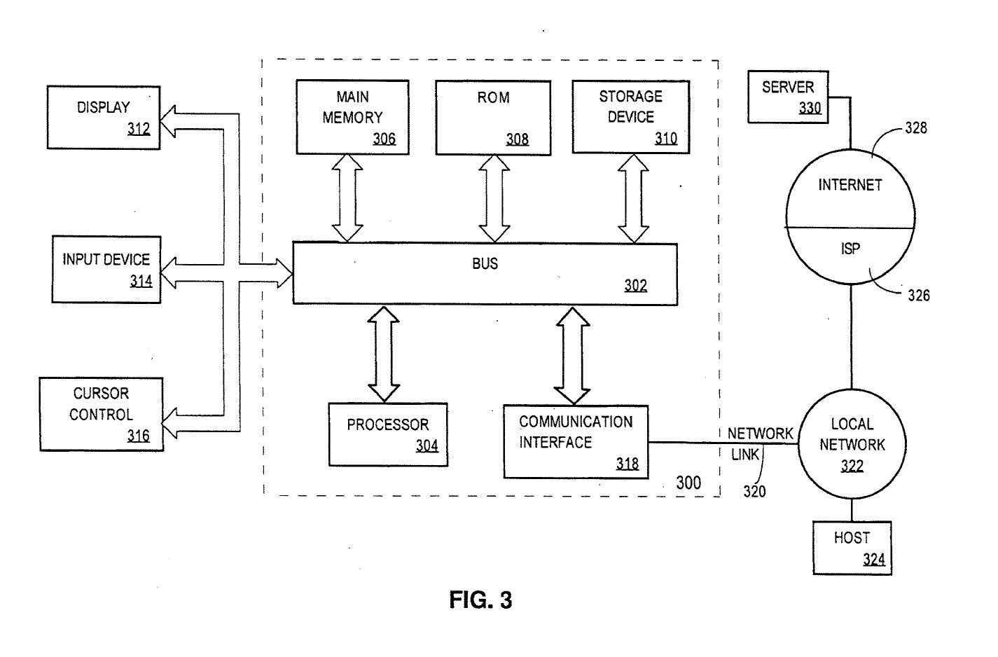

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
receiving a request from a client device for product placement data for a specific item, the request further comprising a location;
determining one or more providers within a proximity to the location that provide the specific item;
obtaining product placement data for the specific item for each of the one or more providers determined; and
transmitting a response comprising the one or more providers determined integrated with the product placement data for the specific item for each of the one or more providers,
wherein the method is performed by one or more special-purpose computing devices.

2. The method of claim 1, wherein the response further comprises promotions for the specific item from a particular provider.

3. The method of claim 1, wherein the response further comprises promotions for items related to the specific item from a particular provider.

4. The method of claim 1, wherein the response further comprises pricing information for the specific item from a particular provider.

5. The method of claim 2, wherein the promotions further comprises a unique identifier that associates the promotion with a subsequent transaction.

6. The method of claim 5, wherein promotions and associated transaction data are aggregated to generate promotion metrics for the provider.

7. The method of claim 1, wherein the location is inserted into the request automatically by the client device.

8. The method of claim 7, wherein the location is based upon a location determined via a cellular network.

9. The method of claim 1, wherein the location is inserted by a user of the client device.

10. The method of claim 1, wherein the request further comprises flags to indicate how a response is sorted.

11. The method of claim 1, wherein the request is via SMS text.

12. The method of claim 1, wherein the client device is a mobile device.

13. A method comprising:
transmitting a request for product placement data for a specific product, the request further comprising a location;
receiving a response comprising integrated data of one or more providers determined to be within a proximity to the location that provide the specific item and the product placement data for the specific item for each of the one or more providers; and
displaying the response to a user,
wherein the method is performed by one or more special-purpose computing devices.

14. The method of claim 13, wherein the response further comprises promotions for the specific item or item related to the specific item from a particular provider.

15. The method of claim 13, wherein the response further comprises pricing information for the specific item from a particular provider.

16. The method of claim 14, wherein the promotions further comprises a unique identifier that associates the promotion with a subsequent transaction.

17. The method of claim 13, wherein the location is inserted into the request automatically.

18. The method of claim 17, wherein the location is based upon a location determined via a cellular network.

19. The method of claim 13, wherein the location is inserted by a user making the request.

20. The method of claim 13, wherein the request further comprises flags to indicate how a response is sorted.

21. A system comprising:
one or more client devices; and
a server;
wherein one or more requests for product placement data of a specific item are transmitted from the one or more client devices to the server, the one or more requests comprising a location based upon a location of the client device transmitting the request;
the server determining one or more providers within a proximity to the location that provide the specific item;
the server obtaining product placement data for the specific item for each of the one or more providers determined;
the server transmitting a response comprising the one or more providers determined integrated with the product placement data for the specific item for each of the one or more providers to the client device transmitting the request; and
the client device receiving the response and displaying the response to a user.

22. The method of claim 21, wherein the response further comprises promotions for the specific item or item related to the specific item from a particular provider.

23. The method of claim 21, wherein the response further comprises pricing information for the specific item from a particular provider.

24. The method of claim 22, wherein the promotions further comprises a unique identifier that associates the promotion with a subsequent transaction.
